(19) United States
(12) Patent Application Publication
(10) Pub. No.: US 2018/0073899 A1
(43) Pub. Date: Mar. 15, 2018

(54) OPTICAL LINEAR ENCODER

(71) Applicant: ZS Systems, LLC, Lafayette, IN (US)

(72) Inventor: Sergey I. Zakharov, Lafayette, IN (US)

(73) Assignee: ZS Systems, LLC, Lafayette, IN (US)

(21) Appl. No.: 15/701,524

(22) Filed: Sep. 12, 2017

Related U.S. Application Data
(60) Provisional application No. 62/393,314, filed on Sep. 12, 2016.

(51) Int. Cl. G01D 5/347; G01D 5/58

(52) U.S. Cl. CPC G01D 5/34746; G01D 5/58

(57) ABSTRACT

An optical linear encoder for measuring distance includes a housing with a glass bar having precision gratings; a reading head body which moves along the housing in a measuring direction; and a carriage which is coupled to the reading head body rigidly in the measuring direction while allowing for minor movements in lateral directions. The carriage includes a scanning reticle guided along the glass bar by the carriage at a constant gap from the glass bar; a photo electronic sensor array which reads variations in intensity of the collimated light passing through both scanning reticle and glass bar, and a light source and a beam forming optics, with the beam forming being performed by an off-axis reflector.

### FIELD OF THE INVENTION

The present invention is directed to a linear encoder for measuring the relative positions of two objects.

### BACKGROUND TO THE INVENTION

Linear encoders are widely used in manufacturing, measurement and control equipment for precise measuring of a distance between 2 movable parts. Applications might include manual and computer numerically controlled metalworking machinery, robotics, semiconductor manufacturing equipment, measuring tables, etc.

In general linear encoders contain two major parts—a scale body and a reading head. The scale body generally comprises a housing and a glass bar with precision gratings. The reading head generally contains a small scanning reticle with gratings, a light source, and a photo detector. By measuring the amount of light passing through the main glass and a scanning reticle, one or more electrical pulses can be generated for every grating period.

A high signal to noise ratio is desirable as it increases reliability by increasing the amount of contamination and electromagnetic interference encoder can safely tolerate.

Two ways of increasing signal to noise ratio are reducing the gap between glass bar and a scanning reticle, and increasing the degree of light source collimation. Reducing the gap is only practical to a certain limit as it requires. Increasingly tight tolerances which results in exponentially higher cost. The second approach requires the use of collimated optics and several embodiments have been known.

It is also beneficial to keep the sensor area as large as practical, since larger area will average out small contaminants and possible manufacturing defects.

The most common approach is to use a collimated lens placed in line with the light source. Examples can be found in U.S. Pat. No. 5,155,355 (FIG. 1) and U.S. Pat. No. 7,185,444 B2 (FIG. 2). The disadvantage of this approach lies in the fact that inline optics increases the encoder dimension in the direction perpendicular to the glass as lens need to have a certain focal distance and aperture enough to light up all of the photosensors. Also lens has two optical surfaces (lens/air boundaries), each of them contributing to losses and generating scattered rays.

Another interesting embodiment is described in U.S. Pat. No. 4,499,374 (FIG. 3). Instead of a lens, in-line reflector is used. While this approach solves some of the issues, it has its own drawbacks. First, placing the light source in a path of collimated beam creates a dark spot in the middle which is in fact requires a larger reflector to produce the same light intensity at the sensors which also has to be deeper to provide the same degree of collimation. In addition, light source require electrical wiring such as PCB traces running through otherwise optically useful area, calling for even larger reflector and more powerful light sources to provide the same intensity at the sensors. More powerful light source generates more heat in close proximity to the scanning reticle or glass and can degrade precision in high accuracy systems. And finally, scattered light from the wiring tracks and supporting PCB reflects back to the mirror and forward, degrading collimation.

A need therefore exists for a linear encoder that avoids the disadvantages of the prior art. The present invention addresses that need.

### SUMMARY

One aspect of the present invention provides an optical linear encoder for measuring distance. One embodiment of the optical linear encoder comprises:
a) a housing with a glass bar where glass bar has precision gratings;
b) a reading head body which moves along the housing in measuring direction; and
c) a carriage which is coupled to the reading head body rigidly in measuring direction while allowing for minor movements in lateral directions.

The carriage comprises:
i) a scanning reticle guided along the glass bar by the carriage at a constant gap from the glass bar;
ii) a photo electronic sensor array which reads variations in intensity of the collimated light passing through both scanning reticle and glass bar;
iii) a light source and
iv) beam forming optics comprising an off-axis reflector, and effective for forming a light beam using said off-axis reflector.

The off-axis reflector of the optical linear encoder may have a parabolic or spherical shape.

The light source of the optical linear encoder may be a surface mounted (SMT) light emitting diode or a bare chip light emitting diode.

The light source may be of a type as close to the point source as possible and may have the smallest emitting area.

The light source of the optical linear encoder may be located outside of the output beam path.

The off-axis reflector may be produced by injection molding and vacuum deposition of reflective material on the front (concave) side.

The off-axis reflector may be produced by casting from transparent epoxy and metalizing the back (convex) side.

The off-axis reflector may be produced as a separate part and attached to the carriage by means of fasteners or adhesives.

The reflecting surface of the off-axis reflector may be produced by injection molding as an integral part of the carriage.

The photoelectric sensors may be grouped together in close proximity.

The reflector may be made out of transparent resin and a reflective surface formed by applying a reflective layer to the outer, convex side.

The light used by the optical linear encoder may be delivered from the light source to the focal point of a reflector by means of a flexible fiber optical cable.

The light source may be located inside of a reader head body.

Another embodiment of the optical linear encoder of the present invention comprises:
a) a housing with a glass bar where glass bar has precision gratings;
b) a reading head body which moves along the housing in measuring direction;
c) a carriage which is coupled to the reading head body rigidly in measuring direction while allowing for minor movements in lateral directions;

wherein said carriage comprises:
i) a scanning reticle guided along the glass bar by the carriage at a constant gap from the glass bar;
ii) a photo electronic sensor array which reads variations in intensity of the collimated light passing through both scanning reticle and glass bar;
iii) a light source effective for providing light to the photo electronic sensor array;
iv) beam forming optics effective for directing light from the light source along a light path to the photo electronic sensor array;

wherein said light source is positioned outside said light path so that light reflected by the beam forming optics does not pass over the light source when travelling along the light path.

### BRIEF DESCRIPTION OF THE DRAWINGS

FIG. 1 shows a linear encoder as described in U.S. Pat. No. 4,499,374.

FIG. 2 shows a linear encoder as described in U.S. Pat. No. 7,185,444.

FIG. 3 shows a linear encoder as described in U.S. Pat. No. 4,499,374.

FIG. 4 shows a three dimensional exploded isometric view of a linear optical encoder according to one embodiment of the present invention.

FIG. 5A shows a perspective view of a linear optical encoder according to one embodiment of the present invention.

FIG. 5B shows an end view, in partial section, of a linear optical encoder according to one embodiment of the present invention.

FIGS. 6A and 6B show a typical size of gratings in relation to the separation gap between a glass bar and a scanning reticle.

FIG. 7 shows a side view, in partial section, of a linear optical encoder according to one embodiment of the present invention.

FIG. 8 shows an alternative embodiment of beam-forming optics useful for linear optical encoders according to the present invention.

FIGS. 9A and 9B show alternative embodiments of a linear optical encoder according to the present invention.

FIG. 10 shows an alternative embodiment of a linear optical encoder according to the present invention.

FIG. 11 shows a side view, in partial section, of a linear optical encoder according to one embodiment of the present invention.

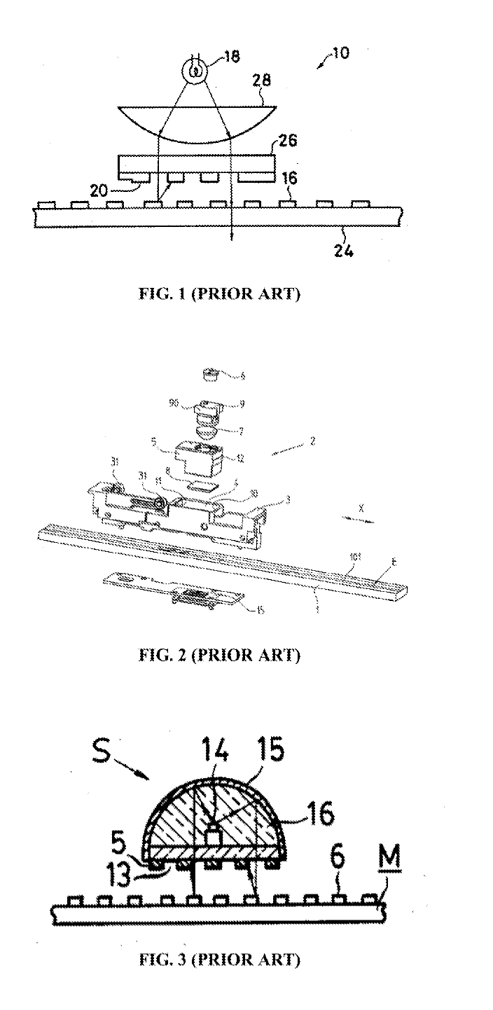

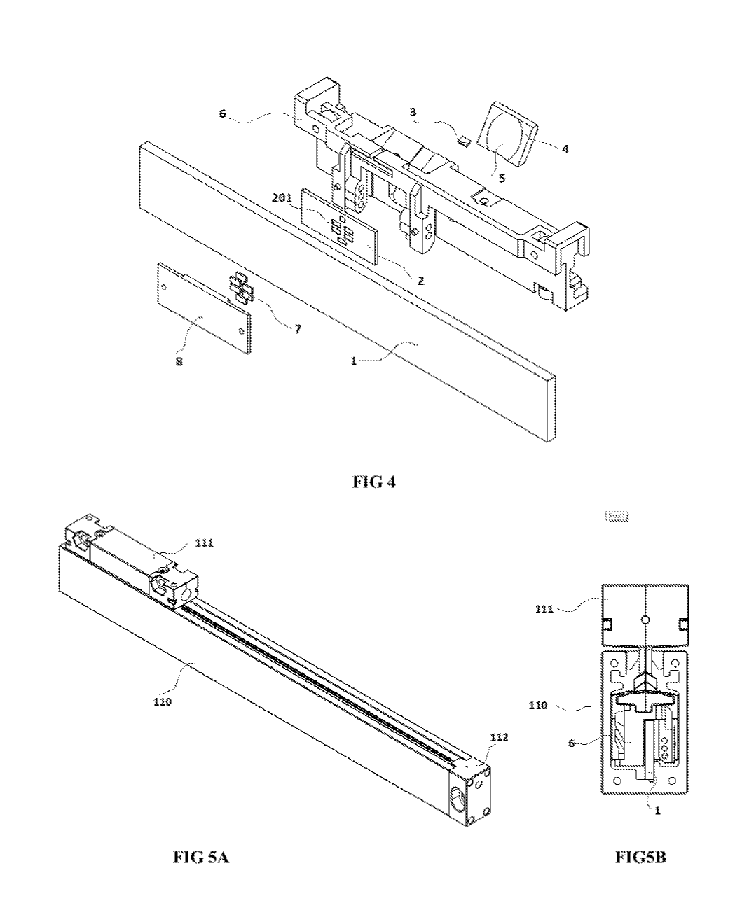

### DESCRIPTION OF THE PREFERRED EMBODIMENTS

For the purposes of promoting an understanding of the principles of the invention, reference will now be made to certain embodiments and specific language will be used to describe the same. It will nevertheless be understood that no limitation of the scope of the invention is thereby intended, with such alterations and modifications to the illustrated device being contemplated as would normally occur to one skilled in the art to which the invention relates.

As indicated above, one aspect of the present invention provides an optical linear encoder for measuring distance and comprising:
a) a housing with a glass bar where glass bar has precision gratings;
b) a reading head body which moves along the housing in measuring direction; and
c) a carriage which is coupled to the reading head body rigidly in measuring direction while allowing for minor movements in lateral directions.

The carriage preferably comprises:
i) a scanning reticle guided along the glass bar by the carriage at a constant gap from the glass bar;
ii) a photo electronic sensor array which reads variations in intensity of the collimated light passing through both scanning reticle and glass bar;
iii) a light source and
iv) beam forming optics comprising an off-axis reflector, and effective for forming a light beam using said off-axis reflector.

More particularly pointing out and distinctly describing various aspects of the present invention, it is to be appreciated that glass has to have a certain width for incremental/absolute grating tracks, and it is beneficial to space some of the optical components in a direction parallel to the glass width instead of perpendicular to it. By utilizing an off-axis reflector, the distance between the reflector and a scanning reticle or glass bar can be greatly reduced and the light source can be placed in more convenient location for a better optimization of the space inside of encoder housing

As light source and its wiring lies outside of the collimated beam path, no dark zones are created and no scattered light harms the performance, no special antireflective treatments necessary for circuit board containing light source. Reflector size and corresponding light power can be reduced while achieving the same light intensity at the sensors.

Additionally, the present invention provides the advantage of low manufacturing cost without new capital investment. Reflectors can be produced on vacuum metallization equipment already used and readily available at optical encoder manufacturing facilities.

Another embodiment utilizes a transparent epoxy resin mirror which is metalized on the outer convex side. Using an off-axis reflector allows all optical surfaces to be formed by mold in a single shot. In comparison, on-axis reflector produced by this method would have to utilize an additional light transmitting base member, as pouring epoxy from the output beam window side would create imperfections from shrinkage and severely increase beam divergence

Another embodiment utilizes a fiber optical cable to deliver light to the focal point of the off-axis reflector. As even state of the art LED light sources are <40% efficient, large amount of energy is being converted into heat. Having a heat source in a close proximity to graduations adversary affects accuracy due-to effects of thermal expansion on the scanning reticle. Removing a major heat source from the tight enclosed space and placing it further away, preferably inside of the reader head body, effectively solves this issue.

The most preferred embodiments of the present invention are illustrated in the accompanying drawings.

FIG. 4 shows three dimensional exploded isometric view of a linear optical encoder which includes a glass bar 1 with precision graduations and a carriage 6 which rides on the glass by means of 5 miniature ball bearings.

FIG. 5A illustrates an isometric view of the linear encoder while FIG. 5B shows a side view with 1 of the end caps 112 removed. Some other components which are outside of the scope of this invention, such as seals, and electrical cables were omitted for clarity purposes. Glass bar 1 is installed inside of a housing 110. Reader head body 111 can move in a direction of measurement with respect to the scale body and a glass bar. Carriage 6 is rigidly coupled to the reader head body 111 in measuring direction, it maintains a precise alignment with the glass bar 1 in directions perpendicular to measuring direction, while reader head body slightly moves in lateral directions. A glass bar can have either incremental graduation track with a reference mark track or absolute graduation code. A scanning reticle 2 has scanning gratings 201 which are designed to produce a certain fringe pattern as reticle translates along measuring direction. A very small constant gap maintained between reticle and glass. Light source 3, preferably LED, collimated by a reflective surface 5 of a reflector 4 to produce a beam with a very little divergence. Photo sensors 7 installed onto sensor PCB assembly 8 detect variations in light intensity as grating patterns on the glass bar and a scanning reticle interact during their relative movement. Those signals are further processed by electronics module and either incremental or absolute position signal is generated.

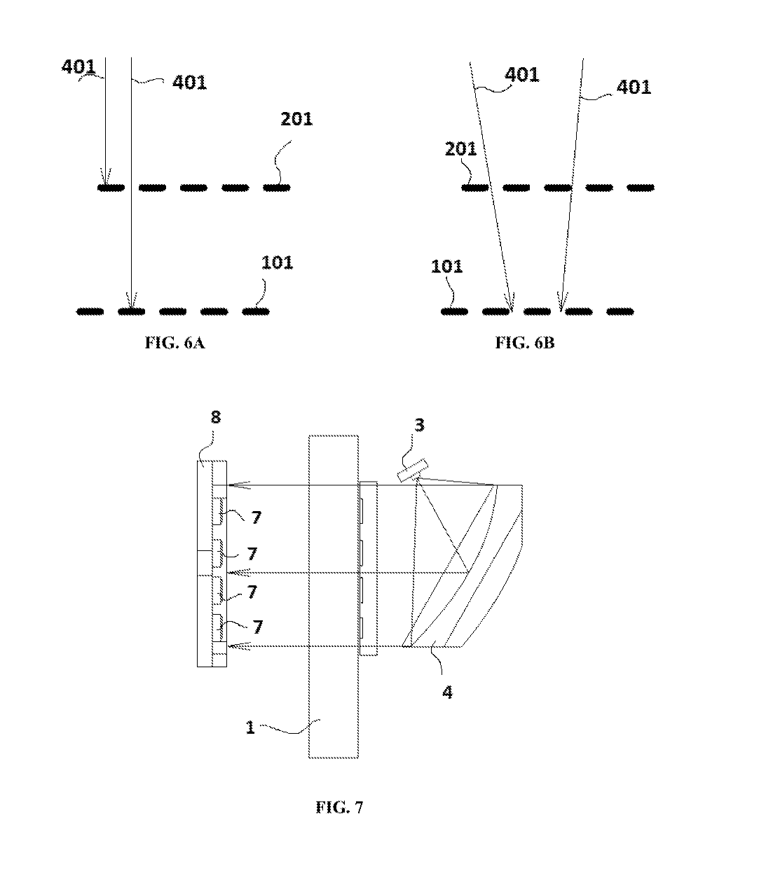

FIGS. 6A and 6B show a typical size of gratings in relation to the separation gap between glass bar 1 and a scanning reticle 2. As gratings are typically not more than 10 um wide, separation gap is maintained at 50 to 100 um as tighter gaps require very tight manufacturing and assembly tolerances at exponential expense. FIG. 6A shows a perfectly collimated light rays 401, while FIG. 6B demonstrates the effect of divergent rays. As gratings are at 180 degree phase to each other, photo sensor should ideally read zero, however real world light source will have some of the rays reaching the grating at other than normal angle which will be allowed to pass and photosensor will read some noise even at 180 degrees. Similar at 0 degree phase shift, photosensor will read less than a theoretical maximum since some of the diverged rays will get scattered and never each photosensor. So importance of having highly collimated light source becomes obvious if one to desire a high Signal to Noise Ratio.

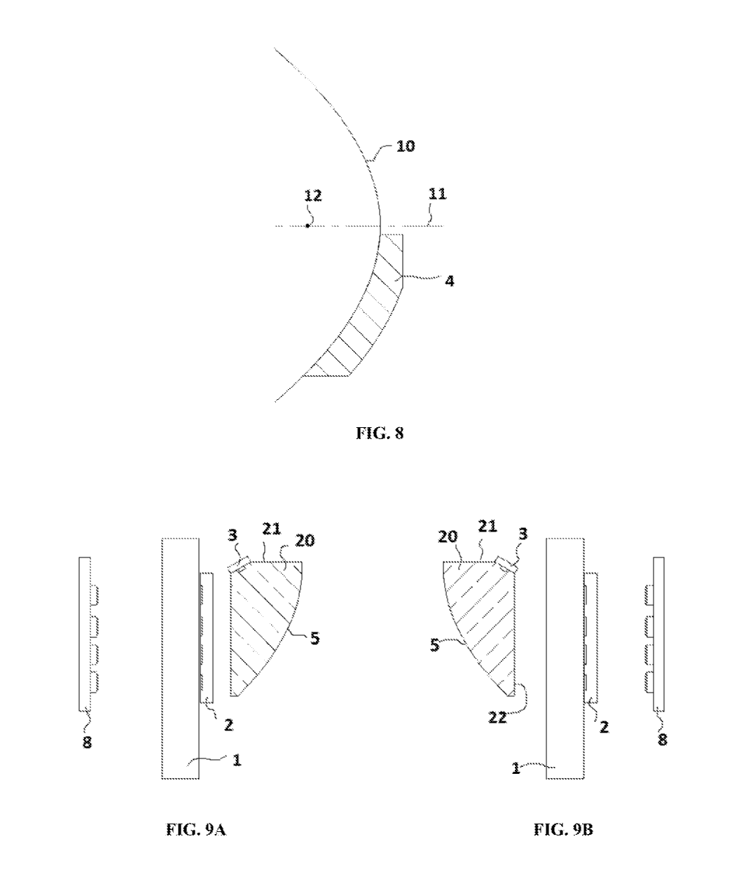

FIGS. 7 and 8 illustrate a proposed beam forming optics. A light source 3, preferably a point source, emits uncollimated light towards a reflective surface 5 of a concave mirror, preferably of a parabolic shape. Location of a light source is chosen so it matches a focal point 12 of the reflector. A three dimensional mirror is obtained by rotating a surface forming curve 10 around axis 11. A small section of a resulting surface is chosen for the reflector in such a way, that it is big enough to fully light all of the photosensors 7 while making sure that light source is not in path of collimated beam.

Such an arrangement allows for a very compact design, as light source and associated wiring are placed right next to the reflector and not behind the optics as would have to be done in case of using collimating lens. This allows one to utilize an available space for the placement of light source and therefore reduces the encoder dimension in a direction perpendicular to the glass bar. Preferred method of manufacturing reflector would be injection molding followed by vapor deposition of a reflective material.

The beam forming optics of FIG. 8 provides an “off-axis” parabolic reflector. As illustrated, an off-axis reflector is made from a segment of the paraboloid which is offset from the axis of symmetry.

Even further reduction in size can be achieved, as shown on FIG. 9A. In this embodiment reflector is made out of a transparent resin 20 and a reflective surface 5 is formed on the outer convex surface, again, preferably by vacuum deposition of a reflective material. Preferred resin type is an epoxy type with refractive index matching that of a transparent light source body. Light source 3 is installed into mold prior to filling it with a resin and then resin is fed through surface 21. Both critical surfaces 5 and 22 are formed by the mold and no further processing is necessary. Any residual surface defects due to resin setting are limited to surface 21 which is not in the optical path and will not affect the performance.

FIG. 9B shows another alternative embodiment which puts beam forming optics on a side of a glass bar 1 and photosensor assembly 8 right behind the scanning reticle 2. This can also be applied to the embodiment shown oh FIG. 7.

FIG. 10 shows an alternative embodiment which was made possible by utilizing off-axis reflector. It uses a flexible fiberoptical cable 501 to deliver light from the light source 3 to the focal point 12 of the off-axis reflector 4. Fiber optical coupling 502 designed to match light source 3 to the cable 501, while coupling 503 produces a lambertian output with wide half angle for the reflector 4. In preferred embodiment light source is located outside of the tightly enclosed space and as far from the scanning area as possible, to avoid errors due-to thermal expansion of scanning reticle. One of such locations made possible by current invention would be inside of a reader head body 111.

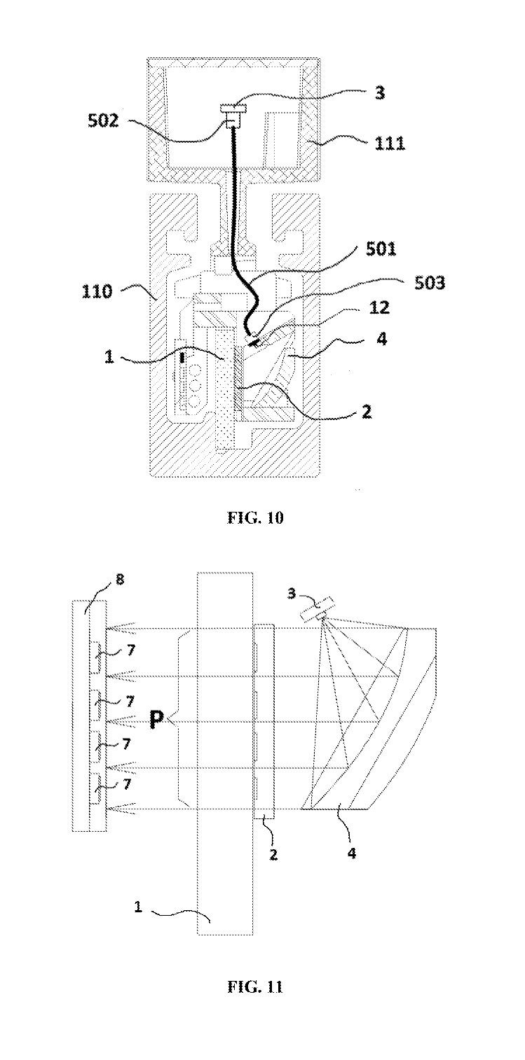

FIG. 11 shows the beam forming optics of FIGS. 7 and 8, with the light path P being illustrated. It can be seen from FIG. 11 that light source 3 is positioned outside light path P. Light source 3 sends light to reflector 4 which reflects the light along light path P through scanning reticle 2 and glass bar 1 to photo sensors 7. Reflector 4 is an off-axis reflector.

While the invention has been illustrated and described in detail in the drawings and foregoing description, the same is to be considered as illustrative and not restrictive in character, it being understood that only certain preferred embodiments have been shown and described, and that all changes and modifications that come within the spirit of the invention are desired to be protected.

Additionally, it is to be appreciated that the present invention may comprise or consist essentially of any or all of the described or illustrated elements. Further, any or all of the features, elements, and/or embodiments disclosed herein may be combined with any or all of the other features, elements, and/or embodiments disclosed herein to provide an invention that comprises or consists essentially of such features, elements, and/or embodiments.

The grammatical device “and/or” (such as in “A and/or B”) is used in this disclosure to mean A alone, or B alone, or both A and B.

1. An optical linear encoder for measuring distance and comprising:
a) a housing with a glass bar where glass bar has precision gratings;
b) a reading head body which moves along the housing in measuring direction; and
c) a carriage which is coupled to the reading head body rigidly in measuring direction while allowing for minor movements in lateral directions;
wherein said carriage comprises:
i) a scanning reticle guided along the glass bar by the carriage at a constant gap from the glass bar;
ii) a photo electronic sensor array which reads variations in intensity of the collimated light passing through both scanning reticle and glass bar;
iii) a light source and
iv) beam forming optics comprising an off-axis reflector and effective for forming a light beam using said off-axis reflector.

2. An optical linear encoder according to claim 1, wherein said off-axis reflector has a parabolic or spherical shape.

3. An optical linear encoder of a claim 1, wherein said a light source is a Surface Mounted (SMT) Light Emitting Diode or Bare Chip Light Emitting Diode.

4. An optical linear encoder according to claim 1, wherein said a light source is of a type as close to point source as possible and having the smallest emitting area.

5. An optical linear encoder according to claim 1, wherein said light source located outside of the output beam path.

6. An optical linear encoder according to claim 1, wherein said off-axis reflector produced by injection molding and vacuum deposition of reflective material on the front (concave) side.

7. An optical linear encoder according to claim 1, wherein said off-axis reflector produced by casting from transparent epoxy and metalizing the back (convex) side.

8. An optical linear encoder according to claim 1, wherein said off-axis reflector produced as a separate part and attached to the carriage by means of fasteners or adhesives.

9. An optical linear encoder according to claim 6, wherein said reflecting surface of the off-axis reflector produced by injection molding as an integral part of the carriage.

10. An optical linear encoder according to claim 1, wherein photoelectric sensors are grouped together in close proximity.

11. An optical linear encoder according to claim 1, wherein reflector is made out of transparent resin and a reflective surface formed by applying a reflective layer to the outer, convex side.

12. An optical linear encoder according to claim 1, wherein light is delivered from the light source to the focal point of a reflector by means of a flexible fiber optical cable.

13. An optical linear encoder according to claim 12, wherein light source is located inside of a reader head body.

14. An optical linear encoder, comprising:
a) a housing with a glass bar where glass bar has precision gratings;
b) a reading head body which moves along the housing in measuring direction;
c) a carriage which is coupled to the reading head body rigidly in measuring direction while allowing for minor movements in lateral directions;
wherein said carriage comprises:
i) a scanning reticle guided along the glass bar by the carriage at a constant gap from the glass bar;
ii) a photo electronic sensor array which reads variations in intensity of the collimated light passing through both scanning reticle and glass bar;
iii) a light source effective for providing light to the photo electronic sensor array;
iv) beam forming optics effective for directing light from the light source along a light path to the photo electronic sensor array;
wherein said light source is positioned outside said light path so that light reflected by the beam forming optics does not pass over the light source when travelling along the light path.
